(19) United States
(12) Patent Application Publication
(10) Pub. No.: US 2013/0089726 A1
(43) Pub. Date: Apr. 11, 2013

(54) PROCESS OF APPLYING POROUS METALLIC STRUCTURE AND COLD-SPRAYED ARTICLE

(71) Applicants: Krishnamurthy ANAND, Bangalore Karnataka (IN); Eklavya CALLA, Bangalore Karnataka (IN); Sheo Narain GIRI, Bangalore Karnataka (IN)

(72) Inventors: Krishnamurthy ANAND, Bangalore Karnataka (IN); Eklavya CALLA, Bangalore Karnataka (IN); Sheo Narain GIRI, Bangalore Karnataka (IN)

(73) Assignee: GENERAL ELECTRIC COMPANY, Schenectady, NY (US)

(21) Appl. No.: 13/270,400

(22) Filed: Oct. 11, 2011

(51) Int. Cl. B32B 5/18; B05D 7/00; B05D 3/02; B05D 5/00; B32B 15/00; B05D 1/12

(52) U.S. Cl. 428/312.8; 427/191

(57) ABSTRACT

A process of applying a porous metallic structure and a cold-sprayed article are disclosed. The process includes cold spraying a solid feedstock and a low-melt material onto an article and removing at least a portion of the low-melt materials or applying a porous metallic structure includes cold spraying onto an article with two converging-diverging nozzles. The cold-sprayed article includes a porous metallic structure having a portion formed from cold spraying a solid feedstock. The portion includes the phases and microstructure of the solid feedstock.

### FIELD OF THE INVENTION

The present invention is directed to metallic articles and process of forming metallic articles. More specifically, the present invention is directed to articles with metallic porous structures and processes for applying metallic porous structures.

### BACKGROUND OF THE INVENTION

Many systems, such as those in gas turbines, are subjected to thermally, mechanically and chemically hostile environments. For example, in the compressor portion of a gas turbine, atmospheric air is compressed to 10-25 times atmospheric pressure, and adiabatically heated to about 800° F. to about 1250° F. in the process. This heated and compressed air is directed into a combustor, where it is mixed with fuel. The fuel is ignited, and the combustion process heats the gases to very high temperatures, in excess of about 3000° F. These hot gases pass through the turbine, where airfoils fixed to rotating turbine disks extract energy to drive the fan and compressor of the turbine, and the exhaust system, where the gases provide sufficient energy to rotate a generator rotor to produce electricity. Tight seals and precisely directed flow of the hot gases provide operational efficiency. To achieve such tight seals in turbine seals and precisely directed flow can be difficult to manufacture and expensive.

To improve the efficiency of operation of turbines, combustion temperatures have been raised and are continuing to be raised. To withstand these increased temperatures, a high alloy honeycomb section brazed to a stationary structure has been used. The high alloy honeycomb can be expensive in material costs, and brazing it to the stationary structure can be expensive.

Other porous, foam, and/or honeycomb components, such as those serving as abradable rub coats, similarly can be expensive or have operational limits. For example, such materials can oxidize or change phase during application of the materials and/or processing of the materials. Welding or brazing of such materials can adversely affect the microstructure and/or mechanical properties of the component. For example, welding or brazing can form a heat affected zone that results in debit of mechanical properties.

An article with a metallic porous structure and process of applying a metallic porous structure not suffering from one or more of the above drawbacks would be desirable in the art.

### BRIEF DESCRIPTION OF THE INVENTION

In an exemplary embodiment, a process of applying a porous metallic structure includes cold spraying a solid feedstock and a low-melt material onto an article and removing at least a portion of the low-melt materials by heating the low-melt material.

In another exemplary embodiment, a process of applying a porous metallic structure includes cold spraying onto an article. The cold spraying is with two converging-diverging nozzles.

In another exemplary embodiment, a cold-sprayed article includes a porous metallic structure having a portion formed from cold spraying a solid feedstock. The portion includes the phases and microstructure of the solid feedstock.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows an exemplary seal arrangement having one layer positioned between a shroud and a blade according to the disclosure.

FIG. 2 shows an exemplary seal arrangement having multiple layers positioned between a shroud and a blade according to the disclosure.

FIG. 3 shows a flow diagram of an exemplary process of applying a metallic porous structure according to the disclosure.

FIG. 4 shows a schematic view of an apparatus for forming an exemplary article having a metallic porous structure applied according to an exemplary process of the disclosure.

FIG. 5 shows a schematic view of an apparatus for forming an exemplary article having a metallic porous structure applied according to an exemplary process of the disclosure.

Wherever possible, the same reference numbers will be used throughout the drawings to represent the same parts.

### DETAILED DESCRIPTION OF THE INVENTION

Provided is an article with a metallic porous structure and process of applying a metallic porous structure not suffering from one or more of the above drawbacks. Embodiments of the present disclosure permit use of lower cost materials at higher temperatures, permit reliance upon brazing and/or welding to be reduced or eliminated, permit structural effects of brazing and/or welding to be reduced or eliminated, prevent phase changes during application and/or processing, reduce or eliminate the formation of a heat affected zone in a component, reduce or eliminate the formation of duplex structure of metallic components, increase strength in comparison to welded or brazed components, extend fatigue life and/or creep life in comparison to welded or brazed components, increase retention of lubricants in pores as porosity by more precise control of feedstock size variation and/or morphology, increased fluid holding capacity resulting in increased lubrication and/or cooling fluid efficiency, or combinations thereof.

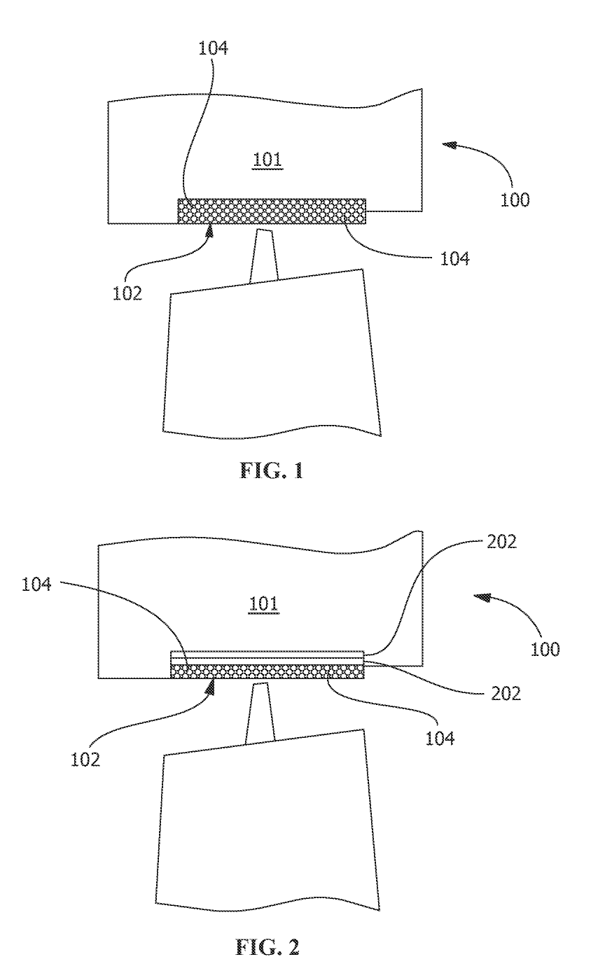

FIGS. 1 and 2 show exemplary articles 100, such as a turbine shroud positioned adjacent to a turbine blade 101, having a porous metallic structure 102, such as a turbine seal 103. The porous metallic structure 102 is positioned directly on a substrate 101 of the article 100 as shown in FIG. 1 or is positioned on one or more intermediate layers 202 on the substrate 101 as shown in FIG. 2.

The article 100 is any suitable metallic component, such as a stationary component or a rotating part. Suitable metallic components include, but are not limited to, compressor components, turbine components, turbine blades, and turbine buckets. The porous metallic structure 102 is any suitable portion or surface of the article 100. In one embodiment, the porous metallic structure 102 is a portion of the article 100, such as, the turbine seal, a compressor seal, a labyrinth seal, a brush seal, a flexible seal, a damping mechanism, a cooling mechanism, buckets interiors, pistons, heat exchangers, or combinations thereof.

The porous metallic structure 102 is or includes any metallic material. As used herein, the term “metallic” is intended to encompass metals, metallic alloys, composite metals, intermetallic materials, or any combination thereof. In one embodiment, the porous metallic structure 102 includes or is stainless steel. In another embodiment, the porous metallic structure 102 includes or is a nickel-based alloy. Other suitable alloys include, but are not limited to, cobalt-based alloys, chromium based alloys, carbon steel, and combinations thereof. Suitable metals include, but are not limited to, titanium, aluminum, and combinations thereof. In one embodiment, the porous metallic structure 102 has little or no equiaxed grains. In one embodiment, the porous metallic structure 102 is devoid of duplex structure, such as a structure having both equiaxed grains and gamma/apha2 lamellae.

The porous metallic structure 102 includes a network of pores 104. In one embodiment, the pores 104 are barely visually discernible or have a fine porosity. In another embodiment, the pores 104 are complex and do not have a consistent geometry, similar to steel wool, or have a coarse porosity. The pores 104 are any suitable size and within any suitable density. Suitable sizes of the pores 104 are between about 1 and about 100 pores per inch, between about 10 and about 50 pores per inch, between about 30 and about 40 pores per inch, between about 50 and about 100 pores per inch, between about 50 and about 70 pores per inch, or combinations thereof. Suitable densities of pores 104 are between about 2% and about 85%, about 15% and about 75%, about 15% and about 25%, about 25% and about 75%, about 2% and about 15%, and combinations and sub-combinations thereof.

Referring to FIG. 2, in one embodiment, the porous metallic structure 102 is positioned on two of the intermediate layers 202, one of which is positioned on the substrate 101 of the article 100. In further embodiments, the porous metallic structure is positioned on three, four, five, or more of the intermediate layers 202. In one embodiment, at least one of the intermediate layers 202 is a bond coat. The bond coat is applied to the substrate 101 or one or more additional bond coats on the substrate 101, for example, by cold spray. In one embodiment, the bond coat is a ductile material, such as, for example, Ti₆Al₄V, Ni—Al, nickel-based alloys, cobalt-based alloys, stainless steels, ferrous alloys, carbon steel, aluminum, titanium, or other suitable materials. The bond coat is applied at a predetermined thickness, for example, between about 2 mils and about 15 mils, between about 2 mils and about 5 mils, between about 5 mils and about 10 mils, between about 10 mils and about 15 mils, between about 2 mils and about 3.0 mils, greater than about 1 mil, greater than about 2 mils, or any suitable combination or sub-combination thereof.

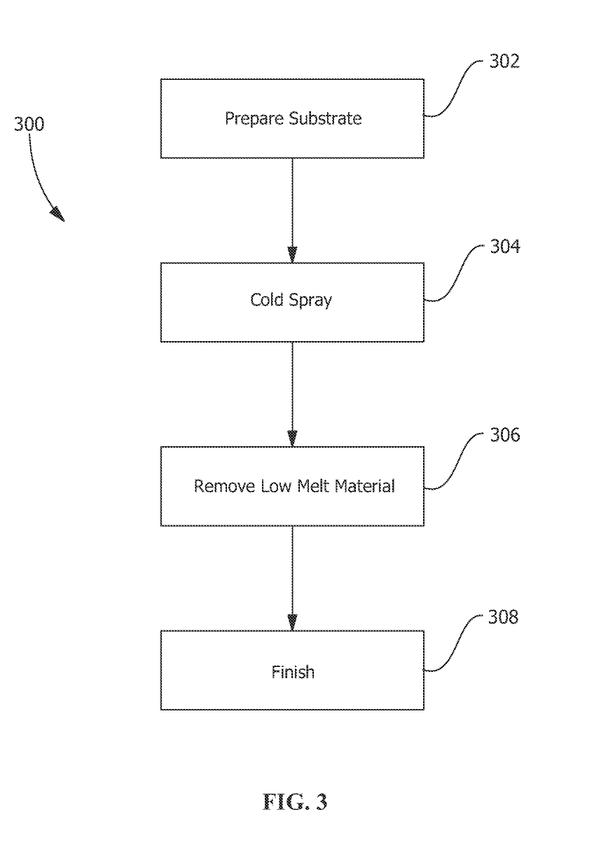

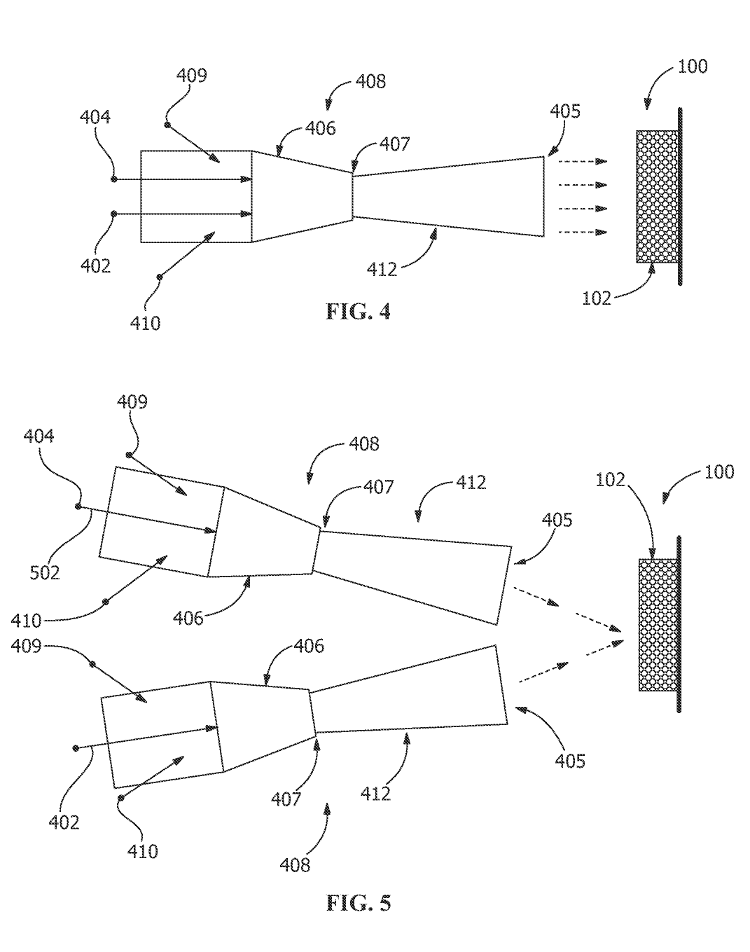

Referring to FIG. 3, in an exemplary process 300 of applying the porous metallic structure 102, the article 100 is prepared (step 302), for example, by cleaning the surface of the article 100. The porous metallic structure 102 is then applied to the article 100 by cold spray (step 304). The cold spraying (step 304) uses a solid/powder feedstock 402 (see FIGS. 4 and 5) and the processing takes place mostly in a solid condition with less heat than processes such as welding or brazing or with negligible heat input from the solid feedstock 402. In one embodiment, the solid feedstock 402 is a pre-alloyed powder and/or a mixture of two or more powders that alloy upon deposition. The solid feedstock 402 has a fine grain size, for example, below about 105 microns, below about 50 microns, below about 25 microns, below about 15 microns, between about 10 and about 105 microns, between about 10 and about 25 microns, between about 10 and about 15 microns, or any suitable combination or sub-combination thereof. In one embodiment, the particle size of the solid feedstock 402 is varied/adjusted, thereby altering the pore size and distribution. For example, based upon how the metallic phase deforms the low melt soft phase and thus pore size and distribution, decreasing the size results in lower kinetic energy (½mv²) and less flattening effect.

Referring to FIG. 4, in one embodiment, the solid feedstock 402 is mixed with a low-melt material 404 within or prior to a converging portion 406 of a converging-diverging nozzle 408. As used herein, the term “low-melt” refers to having a melting point below that of the solid feedstock 402. In one embodiment, the solid feedstock 402 is pre-mixed with the low-melt material 404 providing further adjustability, for example, at any suitable volume concentration. Suitable volume concentrations for the low-melt material are between about 5% and about 90%, between about 5% and about 10%, between about 5% and about 15%, between about 5% and about 20%, between about 5% and about 30%, between about 5% and about 50%, between about 5% and about 60%, between about 5% and about 70%, between about 5% and about 80%, between about 10% and about 90%, between about 20% and about 90%, between about 30% and about 90%, between about 40% and about 90%, between about 50% and about 90%, between about 60% and about 90%, between about 70% and about 90%, between about 80% and about 90%, between about 30% and about 60%, between about 40% and about 50%, or any suitable combination or sub-combination thereof.

The low-melt material 404 is a polymer, a mixture of polymers, a non-polymeric material, a metallic material, or combinations thereof. In one embodiment, the low-melt material 404 is not a polymer. For example, in one embodiment, the low-melt material is a metallic material, such as bismuth and/or tin. The polymer is any suitable polymer or combination of polymers. Suitable polymers include, but are not limited to, polyamide (nylon), nylon with glass fiber reinforcement, poly butylene terepthalate (PBT), polypropylene (PP), polyethylene (PE), polyphenylene sulfide (PPS), a blend of polyphenylene oxide and polystyrene, or combinations thereof. For example, in one embodiment, a combination of polymers is based upon melting points. In a further embodiment, PE is mixed with nylon with glass fiber reinforcement. PE melts at a temperature of about 137° C. Nylon with 30% by volume glass fiber reinforcement melts at about 326° C. In embodiments with the combination of polymers, the porous metallic structure 102 includes porosity that differs at different temperatures.

In one embodiment, the polymer has a predetermined particle thickness, for example, between about 25 microns and about 2000 microns, between about 100 microns and about 2000 microns, between about 200 microns and about 2000 microns, between about 300 microns and about 2000 microns, between about 400 microns and about 2000 microns, between about 400 microns and about 2000 microns, between about 500 microns and about 2000 microns, between about 600 microns and about 2000 microns, between about 700 microns and about 2000 microns, between about 800 microns and about 2000 microns, between about 900 microns and about 2000 microns, between about 1000 microns and about 2000 microns, between about 1100 microns and about 2000 microns, between about 1200 microns and about 2000 microns, between about 1300 microns and about 2000 microns, between about 1400 microns and about 2000 microns, between about 1400 microns and about 2000 microns, between about 1500 microns and about 2000 microns, between about 1600 microns and about 2000 microns, between about 1700 microns and about 2000 microns, between about 1800 microns and about 2000 microns, between about 1900 microns and about 2000 microns, between about 2000 microns and about 2000 microns, between about 25 microns and about 50 microns, between about 25 microns and about 100 microns, between about 100 microns and about 200 microns, between about 25 microns and about 1000 microns, or any combination or sub-combination thereof.

The cold spraying (step 304) forms the porous metallic structure 102 by impacting the solid feedstock 402 particles in the absence of significant heat input to the solid feedstock 402. The cold spraying (step 304) substantially retains the phases and microstructure of the solid feedstock 402. In one embodiment, the cold spraying (step 304) is continued until the porous metallic structure 102 is within a desired thickness range or slightly above the desired thickness range (to permit finishing), for example, between about 1 mil and about 2000 mils, between about 1 mil and about 100 mils, between about 10 mils and about 20 mils, between about 20 mils and about 30 mils, between about 30 mils and about 40 mils, between about 40 mils and about 50 mils, between about 20 mils and about 40 mils, or any suitable combination or sub-combination thereof.

In one embodiment, the cold spraying (step 304) includes accelerating the solid feedstock 402 to at least a predetermined velocity or velocity range, for example, based upon the below equation for a converging-diverging nozzle 408 as is shown in FIG. 4:

$$\frac{A}{{A}^{*}} = {\frac{1}{M} [ \frac{2}{γ + 1} ] [ 1 + ( \frac{γ - 1}{2} ) {M}^{2} ]}^{\frac{γ + 1}{2 ( γ - 1 )}} \qquad ( Equation 1 )$$

In Equation 1, “A” is the area of nozzle exit 405 and “A*” is the area of nozzle throat 407. “γ” is the ratio Cₚ/Cᵥ of a process gas 409 being used (Cₚ being the specific heat capacity at constant pressure and Cᵥ being the specific heat capacity at constant volume). The gas flow parameters depend upon the ratio of A/A*. When the nozzle 408 operates in a choked condition, the exit gas velocity Mach number (M) is identifiable by the equation 1. Gas having higher value for “γ” results in a higher Mach number. The parameters are measured/monitored by sensors 410 positioned prior to the converging portion 406. The solid feedstock 402 impacts the article 100 at the predetermined velocity or velocity range and the solid feedstock 402 bonds to the article 100 to form the porous metallic structure 102.

The nozzle 408 is positioned a predetermined distance from the article 100, for example, between about 10 mm and about 150 mm, between about 10 mm and about 50 mm, between about 50 mm and about 100 mm, between about 10 mm and about 30 mm, between about 30 mm and about 70 mm, between about 70 mm and about 100 mm, or any suitable combination or sub-combination thereof.

In one embodiment, the cold spraying (step 304) includes impacting the solid feedstock 402 in conjunction with a second feedstock, for example, including the low-melt material 404. The low-melt material 404 is injected with the solid feedstock 402, injected separate from the solid feedstock 402 but into the same nozzle 408, injected into a separate nozzle 408, or injected into a diverging portion 412 of the same nozzle 408 or the separate nozzle 408. In an embodiment with the low-melt material 404 injected into the diverging portion 412, the effect of heat, such as degradation of the polymers, from a processing gas is reduced or eliminated. In one embodiment, the low-melt material 404 includes a material susceptible to damage, such as degradation from the heat of the processing gas, up to about 1500° C. The injection in the diverging portion 412 reduces or eliminates such degradation.

Referring to FIG. 5, in one embodiment, the cold spraying (step 304) includes accelerating the solid feedstock 402 and a separate feedstock 502 of the low-melt material 404 to at least a predetermined velocity or velocity range, for example, based upon the equation 1. In one embodiment, the cold spraying (step 304) corresponding to FIG. 5 involves nozzles 408 designed with a combined A/A* ratio to suit spraying a particular material (either a metallic or low melting). In a further embodiment, the cold spraying (step 304) uses different gases in different nozzles 408 and/or includes relative adjustment of other parameters. In one embodiment, multiple nozzles 408 are used to handle incompatibility associated with feedstock having a metallic phase and feedstock having a low melting phase, such as the separate feedstock 502 and the low-melt material 404. The solid feedstock 402 and the separate feedstock 502 impact the article 100 at the predetermined velocity or velocity range and the solid feedstock 402 bonds to the article 100 with the separate feedstock 502 and/or the low-melt material 404 being entrained within the solid feedstock 402 and/or also bonding to the article 100. The parameters are measured/monitored by sensors 410 positioned prior to the converging portion 406.

In a further embodiment, the porosity of the porous metallic structure 102 is controlled by varying an amount of the low-melt material 404 applied in comparison to an amount of the solid feedstock 402 applied. In one embodiment, the amount of the low-melt material 404 is adjustably controlled by varying the amount of the low-melt material 404 applied in comparison to the amount of the solid feedstock 402 while cold spraying (step 304). In this embodiment, the porosity of the porous metallic structure 102 varies based upon these amounts. In a similar embodiment, multiple layers are formed by cold spraying (step 304) more than one application of the low-melt material 404 (or another low-melt material) and the solid feedstock 402 with more than one relative amount of the low-melt material 404 in comparison to the solid feedstock 402.

For example, in one embodiment, the intermediate layer 202 (see FIG. 2) positioned proximate to the substrate 101 or abutting the substrate 101 is less porous than the intermediate layer 202 (see FIG. 2) positioned distal from the substrate 101 or at the surface of the porous metallic structure 102 by the amount of low-melt material 404 applied to form the intermediate layer proximate to the substrate 101 being lower than the amount of the low-melt material 404 applied to form the intermediate layer distal from the substrate 101.

Referring again to FIG. 3, in one embodiment, the process 300 continues after the cold spraying (step 304) by removing (step 306) the low-melt material 404. In one embodiment, the low-melt material is removed (step 306) by heating the low-melt material and the solid feedstock 402 after the cold spraying (step 304) to evaporate, burn, dissolve and/or sublime the low-melt materials. The removing (step 306) of the low-melt material 404 forms the pores 104.

In one embodiment, the process 300 includes finishing (step 308) the porous metallic structure 102 and/or the article 100, for example, by grinding, machining, shot peening, or otherwise processing.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A process of applying a porous metallic structure, comprising:
cold spraying a solid feedstock and a low-melt material onto an article; and
removing at least a portion of the low-melt material by heating the low-melt material.

2. The process of claim 1, wherein the article is a turbine shroud.

3. The process of claim 1, wherein the porous metallic structure is a turbine seal.

4. The process of claim 1, wherein the cold spraying is with a converging-diverging nozzle.

5. The process of claim 1, wherein the cold spraying is with two converging-diverging nozzles.

6. The process of claim 1, wherein the solid feedstock is a pre-alloyed powder or a mixture of two or more powders that alloy upon the cold spraying.

7. The process of claim 1, further comprising mixing the solid feedstock with the low-melt material within a converging-diverging nozzle.

8. The process of claim 1, further comprising pre-mixing the solid feedstock.

9. The process of claim 1, wherein the low-melt material is selected from the group consisting of a polymer, a mixture of polymers, a non-polymeric material, a metallic material, or combinations thereof.

10. The process of claim 1, wherein the low-melt material is bismuth, tin, or a combination of bismuth and tin.

11. The process of claim 1, wherein the low-melt material is selected from the group consisting of polyamide, nylon with glass fiber reinforcement, poly butylene terepthalate, polypropylene, polyethylene, polyphenylene sulfide, a blend of polyphenylene oxide and polystyrene, and combinations thereof.

12. The process of claim 1, wherein the low-melt material is polyethylene mixed with nylon with glass fiber reinforcement.

13. The process of claim 1, wherein the cold spraying substantially retains the phases and microstructure of the solid feedstock.

14. The process of claim 1, wherein the cold spraying further comprises cold spraying a second feedstock.

15. The process of claim 14, wherein the second feedstock includes the low-melt material.

16. The process of claim 1, wherein the low-melt material is injected into a diverging portion of a converging-diverging nozzle.

17. The process of claim 1, wherein the porosity of the porous metallic structure is adjusted by varying the amount of the low-melt material in comparison to the amount of the solid feedstock cold sprayed.

18. The process of claim 1, wherein the heating of the low-melt material evaporates, burns, dissolves or sublimes the low-melt material.

19. A process of applying a porous metallic structure, comprising:
cold spraying onto an article;
wherein the cold spraying is with two converging-diverging nozzles.

20. A cold-sprayed article, comprising:
a porous metallic structure having a portion formed from cold spraying a solid feedstock;
wherein the portion includes the phase and microstructure of the solid feedstock.
